(19) United States
(12) Patent Application Publication
(10) Pub. No.: US 2025/0360517 A1
(43) Pub. Date: Nov. 27, 2025

(54) ELECTRIFICATION PART

(71) Applicant: Hanon Systems, Daejeon (KR)

(72) Inventor: Ji-Yong PARK, Daejeon (KR)

(73) Assignee: Hanon Systems, Daejeon (KR)

(21) Appl. No.: 19/179,985

(22) Filed: Apr. 15, 2025

(30) Foreign Application Priority Data
May 2, 2024 (KR) 10-2024-0058490

(51) Int. Cl. B03C 3/82; B03C 3/38; B03C 3/41

(52) U.S. Cl. CPC B03C 3/82; B03C 3/38; B03C 3/41

(57) ABSTRACT

The present invention relates to an electrification part including a casing having therein an opening formed through two opposite surfaces thereof, a counter electrode coupled to the casing, a discharge electrode disposed to be spaced apart from the counter electrode and coupled to the casing, and a shield member disposed to be spaced apart from the discharge electrode, coupled to the casing, and configured to block electromagnetic waves generated by the discharge electrode.

### CROSS REFERENCE TO RELATED APPLICATION

The present application claims priority to Korean Patent Application No. 10-2024-0058490, filed on May 2, 2024, the entire contents of which are incorporated herein for all purposes by this reference.

### BACKGROUND OF THE INVENTION

### Field of the Invention

The present invention relates to an electrification part that electrifies dust particles so that the dust particles have particular charges by means of a corona discharge phenomenon.

### Description of the Related Art

FIG. 1 is a conceptual view illustrating an electric dust collector in the related art, and FIG. 2 is a perspective view illustrating an electrification part for an electric dust collector in the related art.

As illustrated, the electric dust collector includes an electrification part 10 configured to electrify dust particles so that the dust particles have particular charges by means of a corona discharge phenomenon, and a dust-collecting part 20 configured to collect dust particles electrified by the electrification part.

For example, the electrification part 10 may include a casing 11 having a frame shape and having a central portion penetratively formed in a direction 14 in which dust-containing air is introduced, a plurality of counter electrodes 12 each having a plate shape and two opposite ends coupled to the casing 11, the plurality of counter electrodes 12 being disposed to be spaced apart from one another, and discharge electrodes 13 each having a wire shape and having two opposite sides coupled to the casing 11, the discharge electrodes 13 being disposed between the plurality of counter electrodes 12, spaced apart from one another, and configured to receive a high voltage. Therefore, when a relatively high voltage is applied to the discharge electrodes 13 and a reference voltage (or a ground voltage) is applied to the counter electrodes 12, and an electric field is formed between the discharge electrodes 13 and the counter electrodes 12, such that the dust-containing air may be electrified while passing between the discharge electrodes 13 and the counter electrodes 12 so that dust particles have particular charges. Further, the dust-collecting part may collect the dust particles, which are electrified while passing through the electrification part 10, by means of an electrical attractive force by using opposite charge characteristics.

In this case, when the electrification part operates, a corona discharge occurs along the discharge electrode to which a high voltage is applied, a large number of electrons are produced, and electromagnetic wave noise is released. Further, the discharge electrode having a wire shape generates a large overall amount of electromagnetic wave noise in comparison with a discharge electrode having a pin shape with a sharp end.

Therefore, because the electromagnetic wave noise generated by the electrification part may affect electrical components disposed at the periphery, the electrification part needs to block the electromagnetic wave noise.

### DOCUMENT OF RELATED ART

### Patent Document

KR 10-2634227 B1 (registered on Feb. 1, 2024) “ELECTRIFICATION PART AND ELECTRIC DUCT-COLLECTING DEVICE INCLUDING THE SAME”

### SUMMARY OF THE INVENTION

The present invention is proposed to solve these problems and aims to provide an electrification part that may block electromagnetic wave noise generated from a discharge electrode of the electrification part, thereby preventing electromagnetic wave noise from propagating to electrical components disposed around the electrification part.

In order to achieve the above-mentioned object, the present invention provides an electrification part including: a casing having therein an opening formed through two opposite surfaces thereof; a counter electrode coupled to the casing; a discharge electrode disposed to be spaced apart from the counter electrode and coupled to the casing; and a shield member disposed to be spaced apart from the discharge electrode, coupled to the casing, and configured to block electromagnetic waves generated by the discharge electrode.

In addition, the shield member may be disposed at an upstream side of the casing in a flow direction of air.

In addition, the casing may include: a frame having a frame shape; and a plurality of ribs connected to the frame, a seating groove may be formed in a surface of the rib opposite to a surface facing the discharge electrode, and the shield member may be inserted into the seating groove.

In addition, the shield member may be inserted into the seating groove and disposed inward of an outer surface of the rib.

In addition, a sealing portion made of an electrically insulative material may be applied to an inlet of the seating groove into which the shield member is inserted, such that the shield member is sealed.

In addition, the shield member may be disposed to intersect the discharge electrode.

In addition, the shield member may be disposed to define a right angle with respect to the discharge electrode or disposed to be inclined.

In addition, the shield member may be electrically connected to the counter electrode.

In addition, the electrification part may further include: a connection member coupled to the casing, in which the shield member is in contact with one side of the connection member, and the counter electrode is in contact with the other side of the connection member.

In addition, a through-hole and a fixing groove may be formed in the casing, and the connection member may be inserted and fixed into the fixing groove through the through-hole.

In addition, a fixing protrusion may be formed on the casing, disposed at a position corresponding to the fixing groove, and spaced apart from the fixing groove, and the counter electrode may be inserted between the connection member and the fixing protrusion.

### BRIEF DESCRIPTION OF THE DRAWINGS

FIG. 1 is a conceptual view illustrating an electric dust collector in the related art.

FIG. 2 is a perspective view illustrating an electrification part for an electric dust collector in the related art.

FIGS. 3 and 4 are assembled perspective views illustrating an electrification part according to an embodiment of the present invention.

FIG. 5 is a partially enlarged view of FIG. 3.

FIG. 6 is a top plan view illustrating the electrification part according to the embodiment of the present invention.

FIGS. 7 to 9 are perspective views illustrating states in which a part of a casing of the electrification part according to the embodiment of the present invention is cut away.

FIG. 10 is a partial cross-sectional view illustrating the electrification part according to the embodiment of the present invention.

FIGS. 11 and 12 are cross-sectional views illustrating a coupling structure between a shield member, a connection member, and a counter electrode of the electrification part according to the embodiment of the present invention.

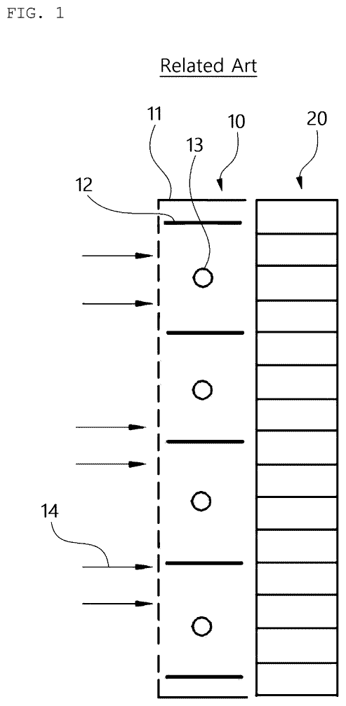

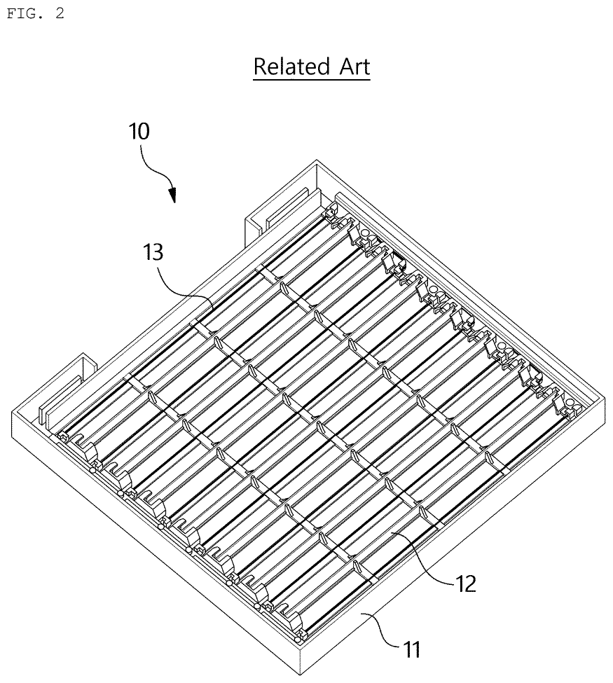

### DETAILED DESCRIPTION OF THE INVENTION

Hereinafter, an electrification part of the present invention configured as described above will be described in detail with reference to the accompanying drawings.

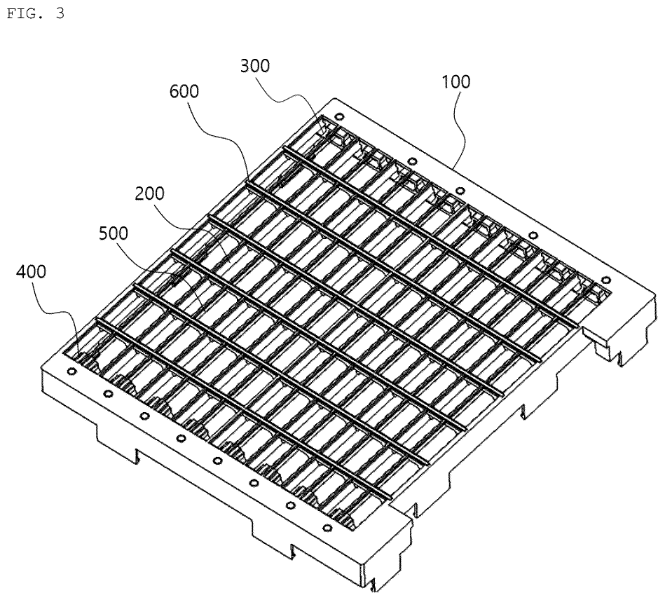

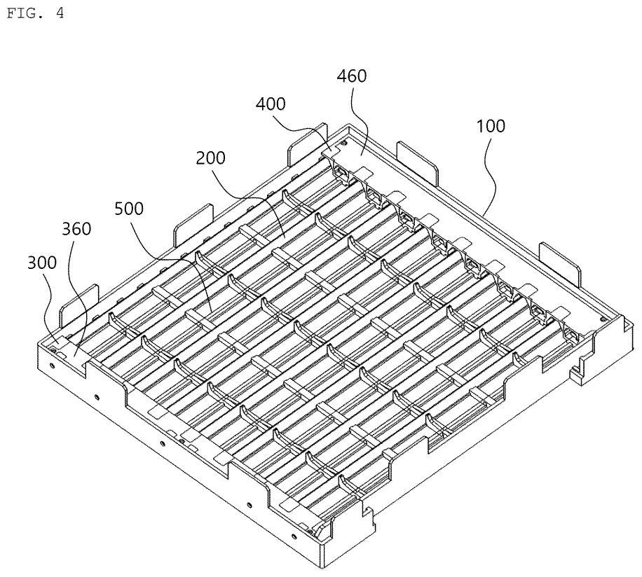

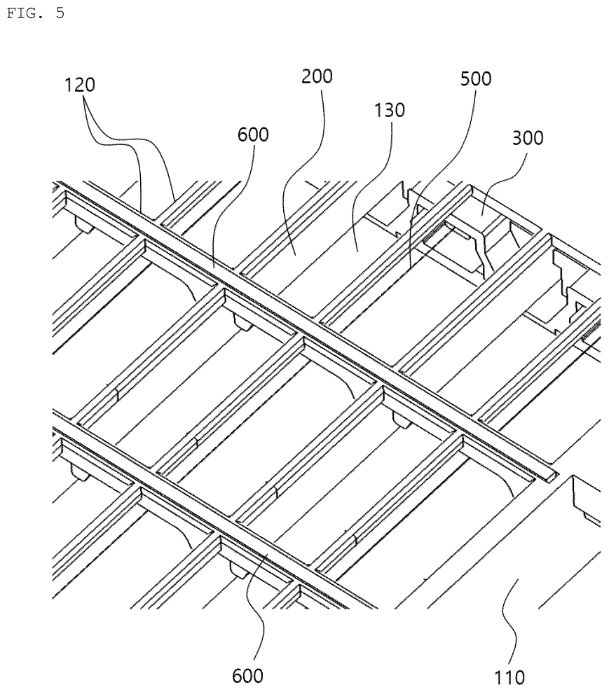

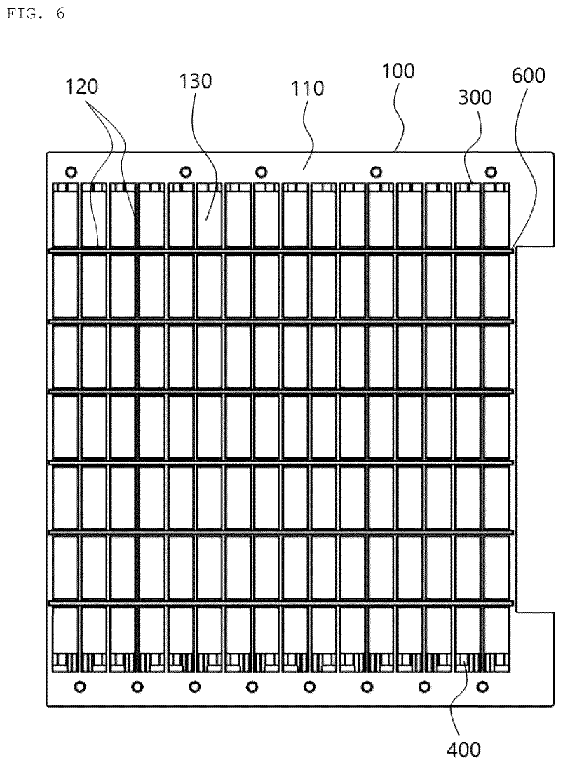

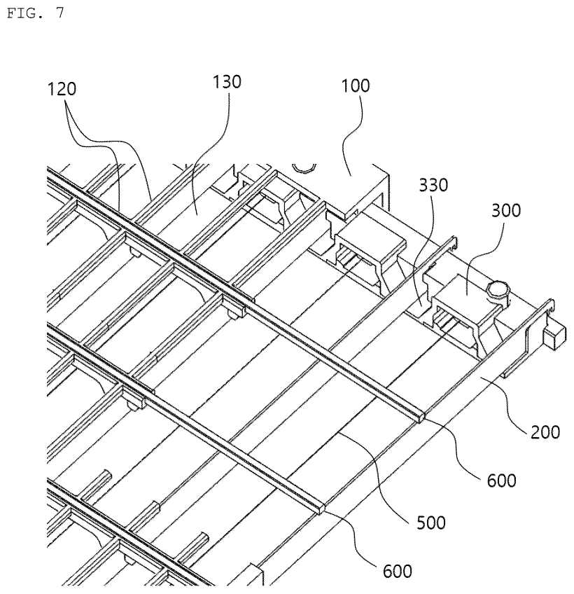

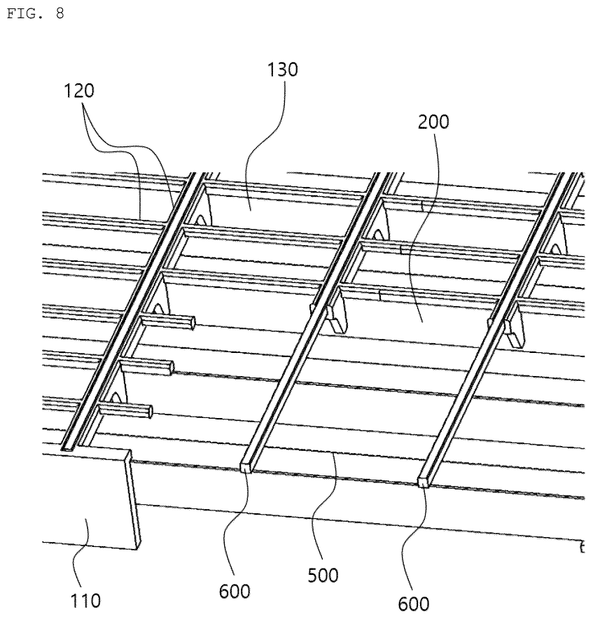

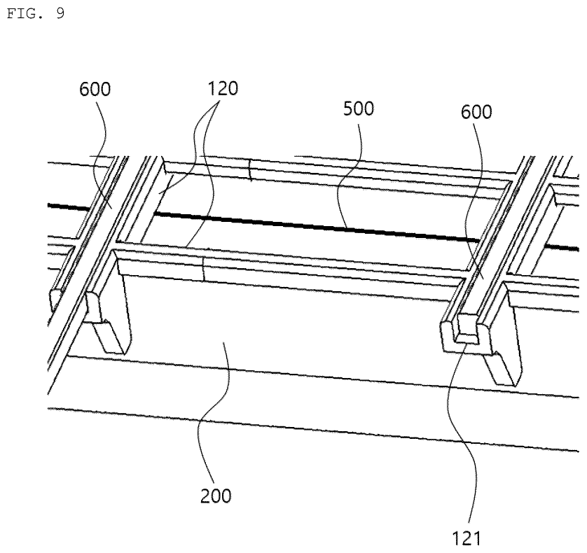

FIGS. 3 and 4 are assembled perspective views illustrating an electrification part according to an embodiment of the present invention, FIG. 5 is a partially enlarged view of FIG. 3, FIG. 6 is a top plan view illustrating the electrification part according to the embodiment of the present invention, and FIGS. 7 to 9 are perspective views illustrating states in which a part of a casing of the electrification part according to the embodiment of the present invention is cut away.

As illustrated, the electrification part according to the embodiment of the present invention may include a casing 100, counter electrodes 200, discharge electrodes 500, and shield members 600 and further include a first support part 300, a second support part 400, a first cover 360, and a second cover 460.

For example, the casing 100 may include a frame 110 having a quadrangular frame shape, and ribs 120 connected inside the frame 110. Openings 130 formed through two opposite surfaces of the casing are formed between the frame 110 and the ribs 120, and air may pass through the openings. Further, the casing 100 may be made of a plastic material or the like with electrical insulation.

For example, the counter electrode 200 may be formed in a plate shape in which a length is larger than a width, and the counter electrode 200 may be made of a metallic material or the like that transmits electricity. The counter electrodes 200 may be provided as a plurality of counter electrodes 200, and the plurality of counter electrodes 200 may be disposed in parallel with one another and spaced apart from one another. Further, the plurality of counter electrodes 200 may be connected to an electrode lead, and a reference voltage or a ground voltage may be applied to the plurality of counter electrodes 200 through the electrode lead. One end of the counter electrode 200 may be coupled to one side of the casing 100, and the other end of the counter electrode 200 may be coupled to the other side of the casing 100.

The first support part 300 may be coupled to one side of the casing 100, and the first support part 300 may cover and block one end of each of the plurality of counter electrodes 200. Fixing portions may protrude from the first support part 300, and one side of the discharge electrode 500 may be fixed by being caught by the fixing portion. Further, counter electrode accommodation portions 330 may be formed on the first support part 300 and disposed at positions corresponding to the counter electrode 200. One side of the discharge electrode 500 may be physically separated from one end of the counter electrode 200 with the first support part 300 interposed therebetween. In addition, the first cover 360 may be coupled to the first support part 300, and the first cover 360 may cover and block an opened portion of the first support part 300.

The second support part 400 may be coupled to the other side of the casing 100, and the second support part 400 may cover and block the other end of each of the plurality of counter electrodes 200. Fixing portions may protrude from the second support part 400, and the other side of the discharge electrode 500 may be fixed by being caught by the fixing portion. Further, counter electrode accommodation portions may be formed on the second support part 400 and disposed at positions corresponding to the counter electrode 200. The other side of the discharge electrode 500 may be physically separated from the other side of the counter electrode 200 with the second support part 400 interposed therebetween. In addition, the second cover 460 may be coupled to the second support part 400, and the second cover 460 may cover and block an opened portion of the second support part 400.

For example, the discharge electrode 500 may have a wire shape, and the discharge electrode 500 may be made of a metallic material or the like that transmits electricity. One side of the discharge electrode 500 may be coupled to the first support part 300, and the other side of the discharge electrode 500 may be coupled to the second support part 400. Further, the discharge electrodes 500 may be provided as a plurality of discharge electrodes 500, and the plurality of discharge electrodes 500 may be disposed in parallel with one another and spaced apart from one another. The discharge electrode 500 may be disposed between the adjacent counter electrodes 200, and the discharge electrode 500 may be disposed to be spaced apart from the counter electrode 200. In addition, the plurality of discharge electrodes 500 may be shaped to be connected into one piece. In addition, an electric wire may be connected to the discharge electrode 500 disposed at the outermost side, such that a high voltage may be applied to the discharge electrode 500.

The shield member 600 may be disposed to be spaced apart from the discharge electrode 500. The shield member 600 may be coupled to the casing 100. Further, the shield member 600 may be disposed at an upstream side of the casing 100 in a flow direction of air. For example, the shield member 600 may be coupled to the ribs 120 of the casing 100, the shield member 600 may be disposed at the upstream side in the flow direction of air, and the counter electrode 200 and the discharge electrode 500 may be disposed at a downstream side. In addition, the shield member 600 may be formed in various shapes such as a quadrangular rod shape or a plate shape. The shield member 600 may be formed continuously along the ribs 120.

Therefore, the shield member of the electrification part of the present invention blocks electromagnetic wave noise generated by a corona discharge, such that the electromagnetic wave noise generated from the electrification part may not affect electrical components disposed at the periphery. In this case, a dust-collecting part is generally disposed at the downstream side of the electrification part in the flow direction of air. Therefore, the electromagnetic wave noise propagating to the downstream side in the flow direction of air may be blocked by the dust-collecting part, and the electromagnetic wave noise propagating to the upstream side in the flow direction of air may be blocked by the shield member of the electrification part.

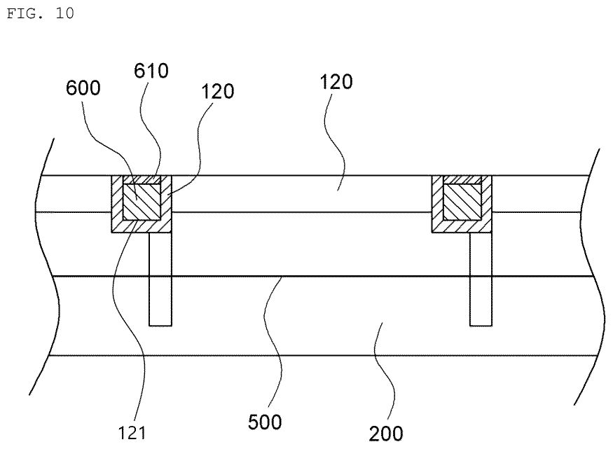

FIG. 10 is a partial cross-sectional view illustrating the electrification part according to the embodiment of the present invention.

As illustrated, seating grooves 121 may be formed in the rib 120, and the shield member 600 may be inserted into the seating groove 121. For example, the seating groove 121 may be formed in a surface of the rib 120 opposite to a surface facing the discharge electrode 500, and the shield member 600 may be inserted into the seating groove 121. Further, the seating groove 121 is formed to have a depth larger than a height of the shield member 600. Therefore, in a state in which the shield member 600 is inserted into the seating groove 121 to the end of the seating groove 121, the shield member 600 may be disposed inward of the surface in which the seating groove 121 is formed. In this case, an insulating material, which is an electrically insulative material, is applied to an inlet of the seating groove 121 into which the shield member 600 is inserted, such that a sealing portion 610 may be formed. Therefore, the shield member 600 may be assuredly insulated, such that the shield member 600 may not be electrically connected to the discharge electrode 500, and the shield member 600 may be securely fixed to the seating groove 121 by the sealing portion 610.

In addition, when viewed in the flow direction of air, the shield member 600 may be disposed to intersect the counter electrode 200 and the discharge electrode 500. For example, as illustrated, the shield member 600 may be disposed to define a right angle with respect to the counter electrode 200 and the discharge electrode 500. In this case, with reference to FIG. 6, based on the flow direction of air, a visible side is a front side, and an invisible side behind the visible side is a rear side. The air may flow from the front side toward the rear side. Alternatively, the shield member 600 may be disposed to be inclined at a particular angle with respect to the counter electrode 200 and the discharge electrode 500. Therefore, the shield member 600 is disposed in parallel with the counter electrode 200 and the discharge electrode 500, such that the electromagnetic wave noise may be effectively blocked.

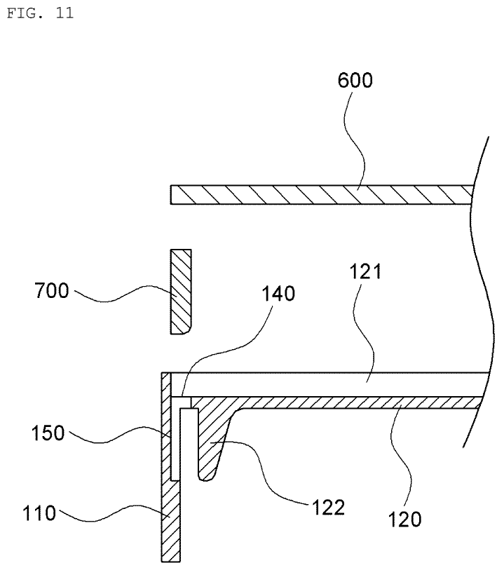

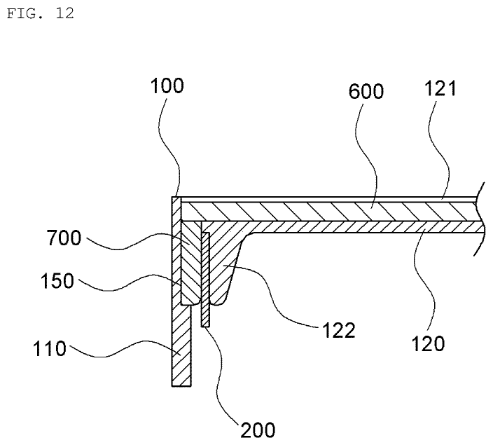

FIGS. 11 and 12 are cross-sectional views illustrating a coupling structure between the shield member, a connection member, and the counter electrode of the electrification part according to the embodiment of the present invention.

As illustrated, the shield member 600 may be electrically connected to the counter electrode 200. For example, the shield member 600 may be electrically connected to the counter electrode 200 disposed at the outermost side.

Further, the electrification part of the present invention may further include a connection member 700 coupled to the casing 100. The shield member 600 may be in contact with one side of the connection member 700, and the counter electrode 200 may be in contact with the other side of the connection member 700. That is, the shield member 600 and the counter electrode 200 may be electrically connected by the connection member 700. For example, a through-hole 140 formed through two opposite surfaces of the casing 100 may be formed in the casing 100, and a fixing groove 150 connected to the through-hole 140 may be formed. The connection member 700 may be inserted and fixed into the fixing groove 150 through the through-hole 140. In this case, a part of the connection member 700 may protrude from the fixing groove 150 toward the inside of the casing 100, such that the connection member 700 may be easily in contact with the counter electrode 200.

In addition, a fixing protrusion 122 may be formed on the casing 100, disposed at a position corresponding to the fixing groove 150, and spaced apart from the fixing groove 150. The counter electrode 200 may be coupled and inserted between the connection member 700 and the fixing protrusion 122. Therefore, the connection member 700 and the counter electrode 200 may be more assuredly in contact with each other.

The shield member of the electrification part of the present invention blocks electromagnetic wave noise generated by a corona discharge, such that the electromagnetic wave noise generated from the electrification part may not affect electrical components disposed at the periphery.

The present invention is not limited to the above embodiments, and the scope of application is diverse. Of course, various modifications and implementations made by any person skilled in the art to which the present invention pertains without departing from the subject matter of the present invention claimed in the claims.

DESCRIPTION OF REFERENCE NUMERALS

| | |
|---|---|
| 100: Casing | 110: Frame |
| 120: Rib | 121: Seating groove |
| 122: Fixing protrusion | 130: Opening |
| 140: Through-hole | 150: Fixing groove |
| 200: Counter electrode | 300: First support part |
| 330: Counter electrode accommodation portion | |
| 360: First cover | |
| 400: Second support part | 460: Second cover |
| 500: Discharge electrode | 600: Shield member |
| 610: Sealing portion | 700: Connection member |

What is claimed is:

1. An electrification part comprising:
a casing having therein an opening formed through two opposite surfaces thereof;
a counter electrode coupled to the casing;
a discharge electrode disposed to be spaced apart from the counter electrode and coupled to the casing; and
a shield member disposed to be spaced apart from the discharge electrode, coupled to the casing, and configured to block electromagnetic waves generated by the discharge electrode.

2. The electrification part of claim 1, wherein the shield member is disposed at an upstream side of the casing in a flow direction of air.

3. The electrification part of claim 1, wherein the casing comprises:
a frame having a frame shape; and
a plurality of ribs connected to the frame,
wherein a seating groove is formed in a surface of the rib opposite to a surface facing the discharge electrode, and
wherein the shield member is inserted into the seating groove.

4. The electrification part of claim 3, wherein the shield member is inserted into the seating groove and disposed inward of an outer surface of the rib.

5. The electrification part of claim 3, wherein a sealing portion made of an electrically insulative material is applied to an inlet of the seating groove into which the shield member is inserted, such that the shield member is sealed.

6. The electrification part of claim 1, wherein the shield member is disposed to intersect the discharge electrode.

7. The electrification part of claim 6, wherein the shield member is disposed to define a right angle with respect to the discharge electrode or disposed to be inclined.

8. The electrification part of claim 1, wherein the shield member is electrically connected to the counter electrode.

9. The electrification part of claim 8, further comprising:
a connection member coupled to the casing,
wherein the shield member is in contact with one side of the connection member, and the counter electrode is in contact with the other side of the connection member.

10. The electrification part of claim 9, wherein a through-hole and a fixing groove are formed in the casing, and the connection member is inserted and fixed into the fixing groove through the through-hole.

11. The electrification part of claim 10, wherein a fixing protrusion is formed on the casing, disposed at a position corresponding to the fixing groove, and spaced apart from the fixing groove, and the counter electrode is inserted between the connection member and the fixing protrusion.
